(19) United States
(12) Patent Application Publication
(10) Pub. No.: US 2024/0034086 A1
(43) Pub. Date: Feb. 1, 2024

(54) TRANSFER PRINTING METHOD OF UV DIGITAL PRINTING

(71) Applicant: GREAT COMPUTER CORP., New Taipei City (TW)

(72) Inventor: Chen-Chien TSAI, New Taipei City (TW)

(21) Appl. No.: 17/878,539

(22) Filed: Aug. 1, 2022

(51) Int. Cl. B41M 5/025; B41M 7/00

(52) U.S. Cl. CPC B41M 5/0256; B41M 7/0081

(57) ABSTRACT

A transfer printing method of UV digital printing, which mainly comprises following steps of: ink jetting a UV ink on a carrier to output a pattern layer in a mirror symmetrical manner and curing the pattern layer through a UV light fully-curing irradiation, wherein the UV ink has low bonding strength to the carrier; and then ink jetting a transparent UV ink on the pattern layer to output a first transparent ink layer and curing the first transparent ink layer through a UV light half-curing irradiation during ink jetting; and, finally, pressing and transferring the pattern layer on the carrier onto a workpiece.

### FIELD OF THE INVENTION

The present invention is related to a transfer printing method of UV digital printing, especially to provide a method that can directly transfer printed pattern to the curved surfaces that cannot be directly printed or larger objects that cannot be placed directly on the printer.

### BACKGROUND OF THE INVENTION

Due to the advancement of printing technology, now printing equipment can print on the upper surface of soft object to be printed (such as paper, cloth or other textiles) or hard object to be printed (such as plastic, metal, glass or ceramic), making it widely used in various industrial fields, in order to increase the visual effect of the appearance of goods. The current printing methods mainly include traditional printing and digital printing.

Since UV digital printing can be applied to a variety of materials, and UV ink is more environmentally friendly than solvent-based inks, it has been widely used and has gradually become the mainstream of digital image output. However, UV digital printing machines still cannot overcome the limitation that traditional digital printing machines can only print on flat objects. Generally, digital printing on simple curved surfaces (the highest and lowest points of the curved surface does not exceed 3 mm) can only be achieved in one direction and at a lower printing speed with large ink droplets, and only special types of inkjet heads can achieve this. During the printing process, the curved surface will also reflect the UV curing light source, which increases the damage rate of the inkjet head. Furthermore, due to the physical limitations of the ink droplets ejection path, not all the curved surfaces in different directions on the object can obtain the same printing effect, and because of the larger ink droplets, the resolution of the printed patterns is lower than the general printing quality. Therefore, the above mentioned method is not widely used. Moreover, there are other methods that utilize first printing on special materials and then transfer or heat transfer, but the procedures are more complicated and must be implemented with the cooperation of special materials or additional equipment (such as thermal laminator or a hot press, etc.).

### SUMMARY OF THE INVENTION

Although the industry has proposed several methods to overcome this innate limitation, some of these methods must sacrifice printing quality and productivity, and some require the use of special materials and cooperate with other processing equipment to indirectly perform transfer with complicate procedures. Therefore, how to effectively solve the printing problem on objects with special curved surfaces or larger objects that cannot be directly placed on the printer has always been the research direction of the inventor.

The main purpose of the present invention is to provide a transfer printing method of UV digital printing with an easy process, low cost that can quickly and efficiently transfer printed patterns to the curved surfaces that cannot be directly printed or larger objects that cannot be directly placed on a printer.

In order to achieve the above object, the present invention provides a transfer printing method of UV digital printing, which mainly comprises following steps of:
Step a: ink jetting a UV ink on a carrier to output a pattern layer in a mirror symmetrical manner and curing the pattern layer through a UV light fully-curing irradiation, wherein the UV ink has low bonding strength to the carrier;
Step b: ink jetting a transparent UV ink on the pattern layer to output a first transparent ink layer and curing the first transparent ink layer through a UV light half-curing irradiation during ink jetting; and
Step c: finally, pressing and transferring the pattern layer on the carrier onto a workpiece.

In implementation, an irradiation intensity of the UV light half-curing irradiation in the Step b is 30% to 60% of a minimum irradiation intensity that the transparent UV ink is capable of being fully cured.

In implementation, in the Step a, after the pattern layer is fully cured, further ink jetting a white UV ink on the pattern layer to output a white ink layer and curing the white ink layer through the UV light fully-curing irradiation.

In implementation, between the Step b and the Step c, the method further comprises a following step of:
Step b1: ink jetting the transparent UV ink on the first transparent ink layer outputted in the Step b to output a second transparent ink layer and after the second transparent ink layer is outputted, curing the second transparent ink layer through a UV light curing irradiation with an irradiation intensity lower than an irradiation intensity of the UV light half-curing irradiation in the Step b.

In implementation, the irradiation intensity of the UV light half-curing irradiation in the Step b is 50% to 80% of a minimum irradiation intensity that the transparent UV ink is capable of being fully cured, while the irradiation intensity of the UV light curing irradiation in the Step b1 is 1% to 10% of the minimum irradiation intensity that the transparent UV ink is capable of being fully cured.

In implementation, the carrier is a release film, a silicone pad, a Polypropylene film, a Teflon film or other materials that has low bonding strength to the UV ink.

In implementation, in the Step a, the UV ink includes a colored ink, a black ink and a white ink.

For further understanding the characteristics and effects of the present invention, some preferred embodiments referred to drawings are in detail described as follows.

### BRIEF DESCRIPTION OF DRAWINGS

FIG. 1 is a flow chart of an embodiment of a transfer printing method of the present invention.

FIG. 2 is a schematic perspective view after the pattern layer is transferred onto the workpiece in the embodiment of the present invention.

FIG. 3 is a schematic diagram of an embodiment of steps of a transfer printing method of the present invention.

FIG. 4 is a flow chart of another embodiment of a transfer printing method of the present invention.

FIG. 5 is a schematic diagram of another embodiment of steps of a transfer printing method of the present invention.

### DETAILED DESCRIPTIONS OF PREFERRED EMBODIMENTS

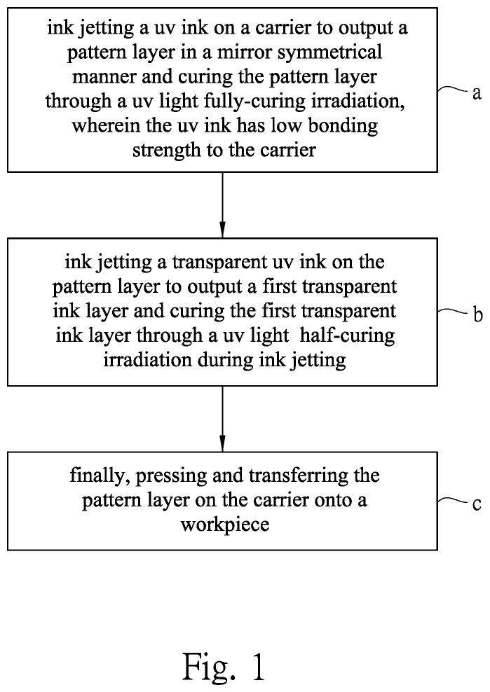

Please refer to FIGS. 1-3, which show a flow chart of an embodiment of a transfer printing method of UV digital printing of the present invention.

A transfer printing method of UV digital printing of the present invention mainly comprises following steps of:
Step a: ink jetting a UV ink on a carrier 1 to output a pattern layer 2 in a mirror symmetrical manner and curing the pattern layer 2 through a UV light fully-curing irradiation, wherein the UV ink has low bonding strength to the carrier;
Step b: ink jetting a transparent UV ink on the pattern layer 2 to output a first transparent ink layer 3 and curing the first transparent ink layer 3 through a UV light half-curing irradiation during ink jetting; and
Step c: finally, pressing and transferring the pattern layer 2 on the carrier 1 onto a workpiece 4.

In the Step a, the UV ink includes a colored ink, a black ink and a white ink. The carrier 1 is a release film, a silicone pad, a Polypropylene film, a Teflon film or other materials that has low bonding strength to the UV ink. An irradiation intensity of the UV light half-curing irradiation in the Step b is 30% to 60% of a minimum irradiation intensity that the transparent UV ink is capable of being fully cured.

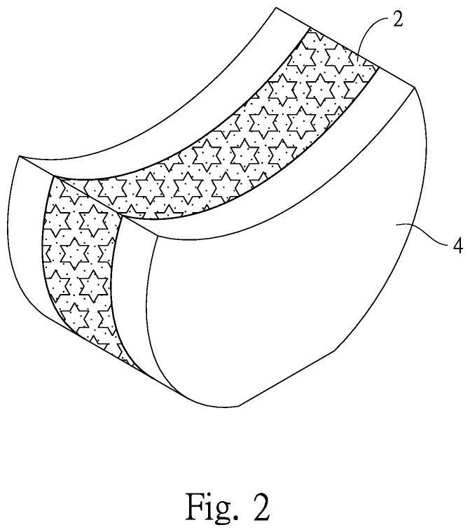

Therefore, in the implementation, taking an example that the workpiece 4 has a block structure with a large curved surface as shown in FIG. 2, firstly, ink jetting a UV ink (such as colored UV ink) on a carrier 1 (release film) to output a pattern layer 2 on the carrier 1 (release film) in a mirror symmetrical manner, wherein the pattern layer 2 is the mirror of a positive orientation pattern desired to be transfer printed onto the workpiece 4, and the pattern layer 2 is cured through a UV light fully-curing irradiation (i.e. the colored UV ink is fully cured). Then, ink jetting a transparent UV ink on the pattern layer 2 to output a first transparent ink layer 3 and curing the first transparent ink layer 3 through a UV light half-curing irradiation during ink jetting. At this moment, the first transparent ink layer 3 is in a half-cured state and it has a certain stickiness. Therefore, finally, when the pattern layer 2 on the carrier 1 is pressed and transferred onto the workpiece 4, the first transparent ink layer 3 is adhered onto the workpiece 4 by its stickiness, so that the pattern layer 2 is completely transferred onto the workpiece 4 and such that the positive orientation pattern is presented on the workpiece 4.

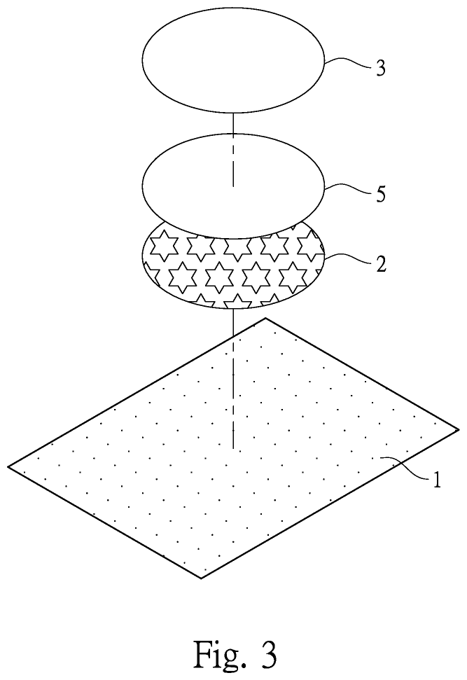

Furthermore, as shown in FIG. 3, in the Step a, after the pattern layer 2 is fully cured, further ink jetting a white UV ink on the pattern layer 2 to output a white ink layer 5 and curing the white ink layer 5 through the UV light fully-curing irradiation. Thereby the pattern layer 2 can be presented on the white ink layer 5 after transferred, so that the transferring process is smoother and the integrity of the pattern layer 2 is protected.

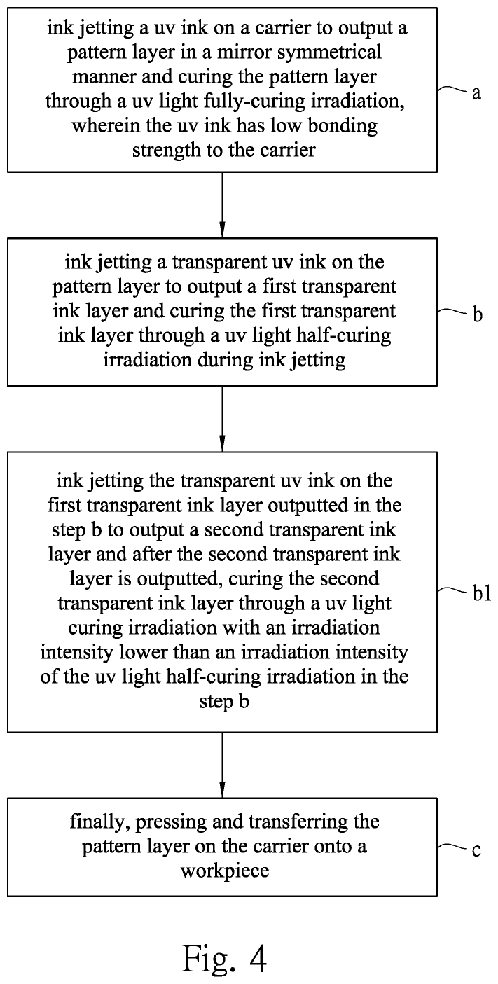

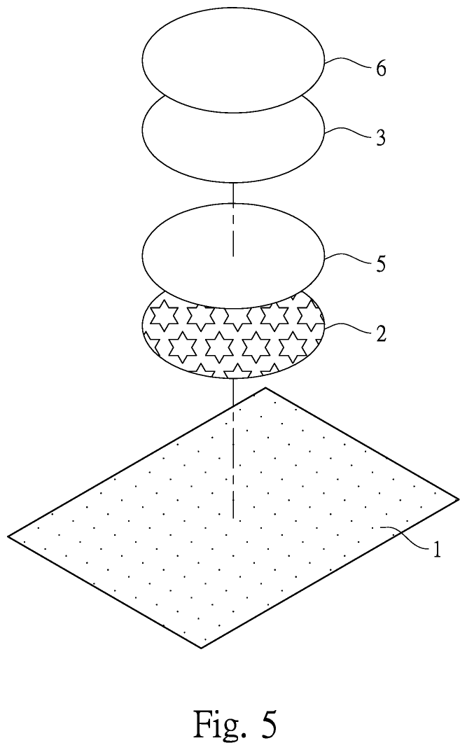

In order to make the pattern layer having better smoothness and flatness, it can be achieved by adding transparent ink in the process. As shown in FIGS. 4 and 5, the complete process steps are as follows:
Step a: ink jetting a UV ink on a carrier 1 to output a pattern layer 2 in a mirror symmetrical manner and curing the pattern layer 2 through a UV light fully-curing irradiation, wherein the UV ink has low bonding strength to the carrier;
Step b: ink jetting a transparent UV ink on the pattern layer 2 to output a first transparent ink layer 3 and curing the first transparent ink layer 3 through a UV light half-curing irradiation during ink jetting;
Step b1: ink jetting the transparent UV ink on the first transparent ink layer 3 outputted in the Step b to output a second transparent ink layer 6 and after the second transparent ink layer 6 is outputted, curing the second transparent ink layer 6 through a UV light curing irradiation with an irradiation intensity lower than an irradiation intensity of the UV light half-curing irradiation in the Step b; and
Step c: finally, pressing and transferring the pattern layer 2 on the carrier 1 onto a workpiece 4.

Wherein, the irradiation intensity of the UV light half-curing irradiation in the Step b is 50% to 80% of a minimum irradiation intensity that the transparent UV ink is capable of being fully cured, while the irradiation intensity of the UV light curing irradiation in the Step b1 is 1% to 10% of the minimum irradiation intensity that the transparent UV ink is capable of being fully cured. Surely, in the Step a, after the pattern layer 2 is fully cured, a white UV ink can be ink jetted on the pattern layer 2 to output a white ink layer 5 and the white ink layer 5 can be cured through the UV light fully-curing irradiation. Thereby the pattern layer 2 can be presented on the white ink layer 5 after transferred, so that the transferring process is smoother and the integrity of the pattern layer 2 is protected.

Since the second transparent ink layer 6 is in a slightly-cured state and it has a certain stickiness, finally, when the pattern layer 2 on the carrier 1 is pressed and transferred onto the workpiece 4, the second transparent ink layer 6 is adhered onto the workpiece 4 by its stickiness, so that the pattern layer 2 is completely transferred onto the workpiece 4 and such that the positive orientation pattern is presented on the workpiece 4.

In this way, the present invention utilizes the characteristics of the UV ink which has poor low bonding strength to certain materials (such as release film, silicone pad, Polypropylene film, Teflon film and etc.), to firstly print out the mirrored pattern of the desired output pattern on these release carrier materials. Then use the above steps to print out a layer of half-cured or slightly-cured ink layer with stickiness, and then to press the mirrored pattern onto the curved surface or the workpiece to be transferred. Finally, remove the release materials to complete the transferring process. Due to the continuous reaction characteristics of the half-cured or slightly-cured ink, good adhesion can be obtained after being placed for several hours or good adhesion can be obtained immediately to directly cure the half-cured or slightly-cured ink through UV light. Through the method of the present invention, the curved surfaces that cannot be directly printed or larger objects that cannot be directly placed on the printer cab be dealt with, so that the pattern can be formed on the workpiece effectively and quickly.

As disclosed in the above description and attached drawings, the present invention can provide a transfer printing method of UV digital printing. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A transfer printing method of UV digital printing comprising following steps of:
Step a: ink jetting a UV ink on a carrier to output a pattern layer in a mirror symmetrical manner and curing said pattern layer through a UV light fully-curing irradiation, wherein said UV ink has low bonding strength to said carrier;
Step b: ink jetting a transparent UV ink on said pattern layer to output a first transparent ink layer and curing said first transparent ink layer through a UV light half-curing irradiation during ink jetting; and
Step c: pressing and transferring said pattern layer on said carrier onto a workpiece.

2. The transfer printing method of UV digital printing according to claim 1, wherein an irradiation intensity of said UV light half-curing irradiation in said Step b is 30% to 60% of a minimum irradiation intensity that said transparent UV ink is capable of being fully cured.

3. The transfer printing method of UV digital printing according to claim 1, wherein in said Step a, after said pattern layer is fully cured, further ink jet a white UV ink on said pattern layer to output a white ink layer and cure said white ink layer through said UV light fully-curing irradiation.

4. The transfer printing method of UV digital printing according to claim 3, wherein between said Step b and said Step c, said method further comprises a following step of:
Step b1: ink jetting said transparent UV ink on said first transparent ink layer outputted in said Step b to output a second transparent ink layer and after said second transparent ink layer is outputted, curing said second transparent ink layer through a UV light curing irradiation with an irradiation intensity lower than an irradiation intensity of said UV light half-curing irradiation in said Step b.

5. The transfer printing method of UV digital printing according to claim 4, wherein said irradiation intensity of said UV light half-curing irradiation in said Step b is 50% to 80% of a minimum irradiation intensity that said transparent UV ink is capable of being fully cured, while said irradiation intensity of said UV light curing irradiation in said Step b1 is 1% to 10% of said minimum irradiation intensity that said transparent UV ink is capable of being fully cured.

6. The transfer printing method of UV digital printing according to claim 1, wherein between said Step b and said Step c, said method further comprises a following step of:
Step b1: ink jetting said transparent UV ink on said first transparent ink layer outputted in said Step b to output a second transparent ink layer and after said second transparent ink layer is outputted, curing said second transparent ink layer through a UV light curing irradiation with an irradiation intensity lower than an irradiation intensity of said UV light half-curing irradiation in said Step b.

7. The transfer printing method of UV digital printing according to claim 6, wherein said irradiation intensity of said UV light half-curing irradiation in said Step b is 50% to 80% of a minimum irradiation intensity that said transparent UV ink is capable of being fully cured, while said irradiation intensity of said UV light curing irradiation in said Step b1 is 1% to 10% of said minimum irradiation intensity that said transparent UV ink is capable of being fully cured.

8. The transfer printing method of UV digital printing according to claim 1, wherein said carrier is a release film, a silicone pad, a Polypropylene film or a Teflon film that has low bonding strength to said UV ink.

9. The transfer printing method of UV digital printing according to claim 1, wherein in said Step a, said UV ink includes a colored ink, a black ink and a white ink.
